(19) United States
(12) Patent Application Publication
(10) Pub. No.: US 2004/0186790 A1
(43) Pub. Date: Sep. 23, 2004

(54) Method and apparatus for supplying coded labels

(76) Inventors: Peter David Sinclair Briggs, Taverham Norwich (GB); Matthew Scott Howarth, Athens, GA (US); Locke A. Chastaine, Campbell, CA (US); Richard G. Evans, Campbell, CA (US)

Correspondence Address: Bruce H. Johnsonbaugh, Eckhoff & Hoppe, 333 Sacramento Street, San Francisco, CA, 94111, US

(21) Appl. No.: 10/769,166

(22) Filed: Jan. 30, 2004

Related U.S. Application Data
(63) Continuation of application No. 09/816,036, filed on Mar. 22, 2001, now abandoned.

(51) Int. Cl. G06F 17/60; B32B 31/00

(52) U.S. Cl. 705/26; 156/64; 156/247; 705/28

(57) ABSTRACT

An Internet based method for ordering and supplying selected coded labels to be applied to a variety of fruits and vegetables at a plurality of labelling sites is provided. The supply of different coded labels at each labelling site is continuously and automatically inventoried. The inventorying is facilitated by the use of a data tag carried by the core on which a label strip is wound, the data tag including data sufficient to uniquely identify the labels carried by that core including the specific label identify and quantity. The label inventory for each of the labelling sites is stored. Approved customers or representatives may access the stored inventory data and display the data on a computer monitor and may order additional selected labels for one or more of the labelling sites.

### BACKGROUND AND BRIEF SUMMARY

The present invention relates generally to systems for applying coded adhesive labels automatically to fruits and vegetables. More particularly, the present invention relates to an Internet based method for automatically counting, inventorying and ordering various coded labels to be applied to a variety of fruits and/or vegetables at a plurality of labelling sites. The present invention also includes apparatus to implement the overall system, namely, a novel label roll having a uniquely coded data tag on the core of labels, which enables counting the number and type of labels applied and verifying the proper use of labels.

The use of coded labels on fresh fruits and vegetables has increased steadily. As the retailers increase their reliance on coded labels on produce, it becomes increasingly important that proper labels are on hand at packhouses and other labelling sites at the proper times to be applied. Also, it becomes more critical that the produce labelling process actually applies labels to all fruits and vegetables intended to be labelled. For example, if one million fresh, ripe peaches are ready to be packed and labelled, and if the proper labels are not on hand at the labelling site, a serious loss will almost certainly occur. The retailer may not accept delivery of those unlabelled peaches. Furthermore, those peaches may spoil in the several days required to deliver the proper labels to the labelling site. Similar losses could occur if the wrong labels are applied to those peaches, or if the labelling equipment malfunctions. These are typical prior art problems sought to be minimized or overcome by the present invention.

The prior art includes automatic high speed labelling machines using label cassettes, as shown in U.S. Pat. No. 4,896,793 and European patent No. 0 113 256 B1. In prior art high speed labelling machines, labels are dispensed from the machine onto objects such as fruit or vegetables from a strip of carrier material having labels provided at intervals therealong. The strip is wound on a core and is carried by a cassette that can be removably mounted on the labelling machine. This arrangement provides for rapid replacement of a fresh supply of labels when a cassette is exhausted without having to stop the labelling machine, which is obviously an important consideration in high speed labelling. However this type of system can give rise to another problem. If the cassette placed on the labelling machine has been loaded with labels that are not appropriate to the objects to be labelled, incorrect labelling of those objects is the result. This may not be noticed, in which case, a large number of incorrectly labelled objects may find their way into retail outlets giving rise to the problems already discussed. Even if it is noticed in the location where labelling is taking place, it can be a time consuming exercise to attempt to retrieve all the incorrectly labelled objects, remove the labels from them and rerun them through the labelling machine with the correct label.

The high speed labelling machines of the kind under consideration have to be made to a very high standard of precision engineering if they are to run, as far as possible, in a trouble-free manner while labelling. For trouble-free operation, it is necessary that the core on which the labels are provided should be appropriate for use with the labelling machine. If an inappropriate or non-approved core or cassette is used in a labelling machine, it can cause serious operational problems such as damage to the labelling machine.

The prior art requires a manual inventory of specific labels on hand at each separate labelling site. Orders for new labels are typically placed by customers on an “as needed” basis or by projecting the demand. Unfortunately, the prior art labelling systems too frequently allow the customer to run out of proper labels when needed. Some customers obtain “nonapproved” labels from sources other than the manufacturer of the labelling machine (or sources approved by the equipment manufacturer). Those “non-approved” labels in some cases cause the automatic labelling machines to malfunction, and the customer's losses escalate.

The present invention provides a method for automatically counting the number of different labels on hand at a plurality of labelling sites. The invention also provides a method for ordering labels in time to prevent running out of specific labels at specific labelling sites. The present invention can detect and prevent the use of non-approved labels, if desired.

A significant aspect of the invention is the use of a novel data tag carried by the core of each label roll. The data tag contains information uniquely identifying the type and quantity of labels carried by the specific label roll. The data tags are machine readable and provide further advantages discussed below. The use of such data tags on label rolls is not known in the prior art.

A primary object of the invention is to provide a method for automatically inventorying and counting the number and identity of labels to be applied to produce on hand at a plurality of labelling sites.

A second significant object of the invention is to provide a data tag carried by the core of each label roll, the data tag carrying machine readable information uniquely describing the number and identity of labels carried by that specific roll.

A further object of the invention is to provide an Internet based method for ordering and supplying coded labels for use at a plurality of labelling sites.

A further object of the invention is to provide a method and apparatus to automatically insure that approved and correct labels are applied to a specific type of produce.

A further object of the invention is to provide a method for providing automatic reminders when automatic labelling machines should be serviced, for providing automatic billing statements for customers' use of the labelling machines, and for providing automatic warnings when any specific label inventory becomes low at any labelling site.

Other objects and advantages of the invention will become apparent from the following description and drawings.

### BRIEF DESCRIPTION OF THE DRAWINGS

FIG. 1 is a schematic representation of the system for ordering and supplying selected coded labels;

FIG. 2 is a perspective view of a roll of labels in accordance with the present invention;

FIG. 3 is an exploded, perspective view showing how the label roll of FIG. 2 can be utilized in a cassette known in the art;

FIG. 4 is an exploded, perspective view showing the connections between the label roll of FIG. 2 through the cassette of FIG. 3 and to the reader/controller for the RF tag option;

FIG. 5 is an exploded, perspective view showing the connections between the label roll of FIG. 2 through the cassette of FIG. 3 and the reader/controller for the contact tag option;

FIG. 6 is a flow chart illustrating the automatic counting and inventorying of labels at n labelling sites and how new labels are ordered;

FIG. 7 is a flow chart illustrating how newly delivered rolls of labels are automatically added to inventory;

FIG. 8 is a flow chart illustrating how the data tags on specific label cassettes are machine read before a labelling run is commenced to verify that the cassette is approved and is the correct cassette for the specific produce to be labelled;

FIG. 9 is a flow chart illustrating the alternate steps where a customer is able to run nonapproved labels; and

FIG. 10 is a flow chart illustrating how label inventory on hand can be automatically compared to historical label demand, and warnings generated if label inventory falls to a predetermined level.

### DETAILED DESCRIPTION OF THE DRAWINGS

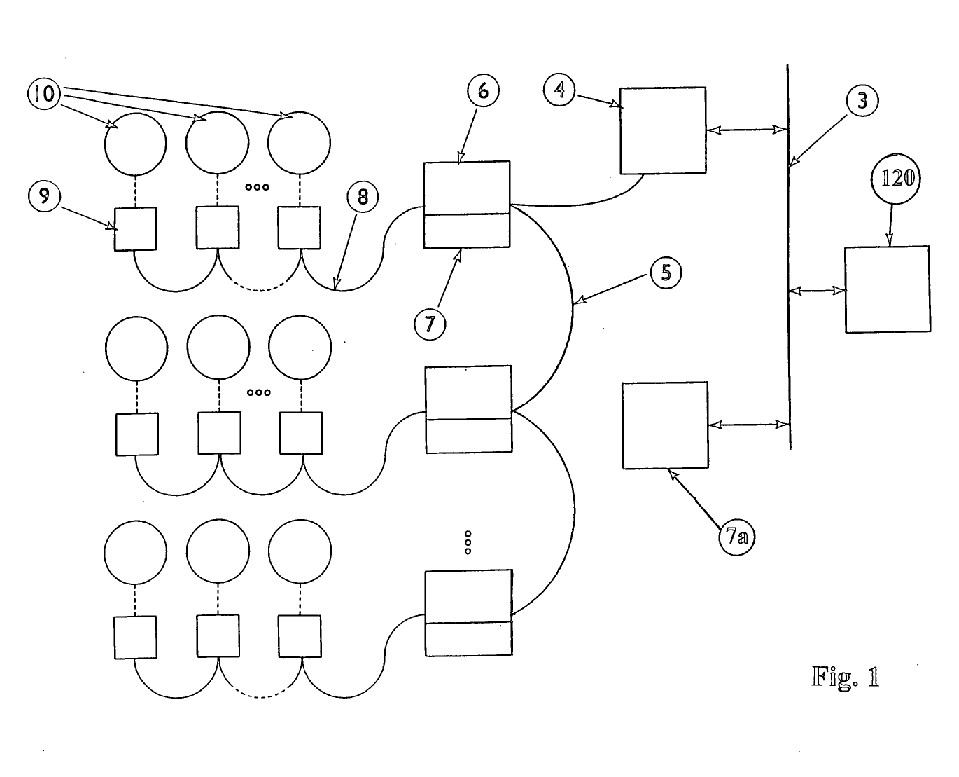

The system shown in FIG. 1 comprises individual label cassettes 10 each containing a label strip wound onto a core which are, in use, mounted on labelling apparatus. The labelling machines are physically located at different labelling sites. A reader/controller 9 is embedded into a label applicator (not shown) upon which the label cassette 10 is removably mounted. This controller is operable to receive data of a kind to be described in more detail hereinafter. A respective machine communication network 8 links each reader/controller 9 to a machine controller 6 and uses a RS485 network protocol. The machine controller 6 communicates data received over a suitable local network 5 to a site server 4 upon which the data can be processed, bundled, sent to a system database 120 and stored on a central data storage medium. The local area network 5 between machine controllers 6 and the site server 4 also uses a RS485 network protocol. Other protocols such as CAN, RS422 or ethernet could be used for either or both the machine or local area networks. Data is sent daily from the site server 4 to the system database 120 via the Internet 3 (a private network could alternately be used). A user interface 7 is provided which enables selected users to access, interrogate, and set-up labelling machines. Another user interface 7a will be provided via the local network 5 and the Internet 3. Through these interfaces, selected users may be able to monitor label consumption, perform machine diagnostics and order labels.

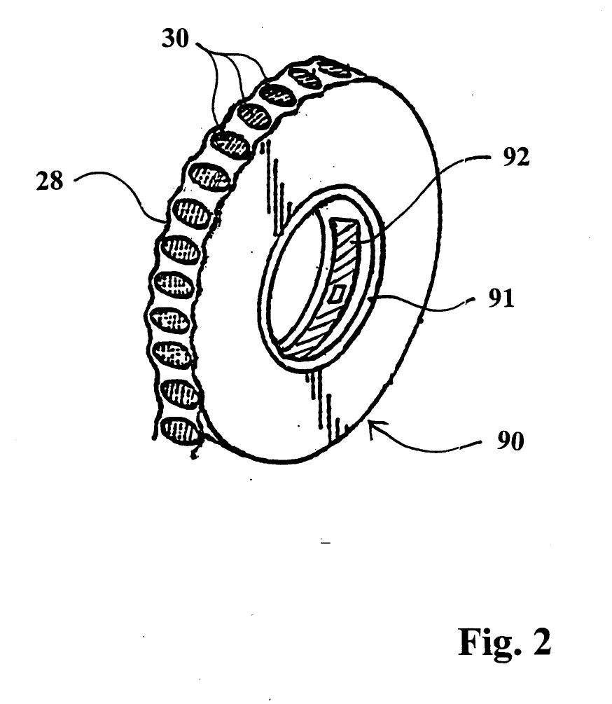

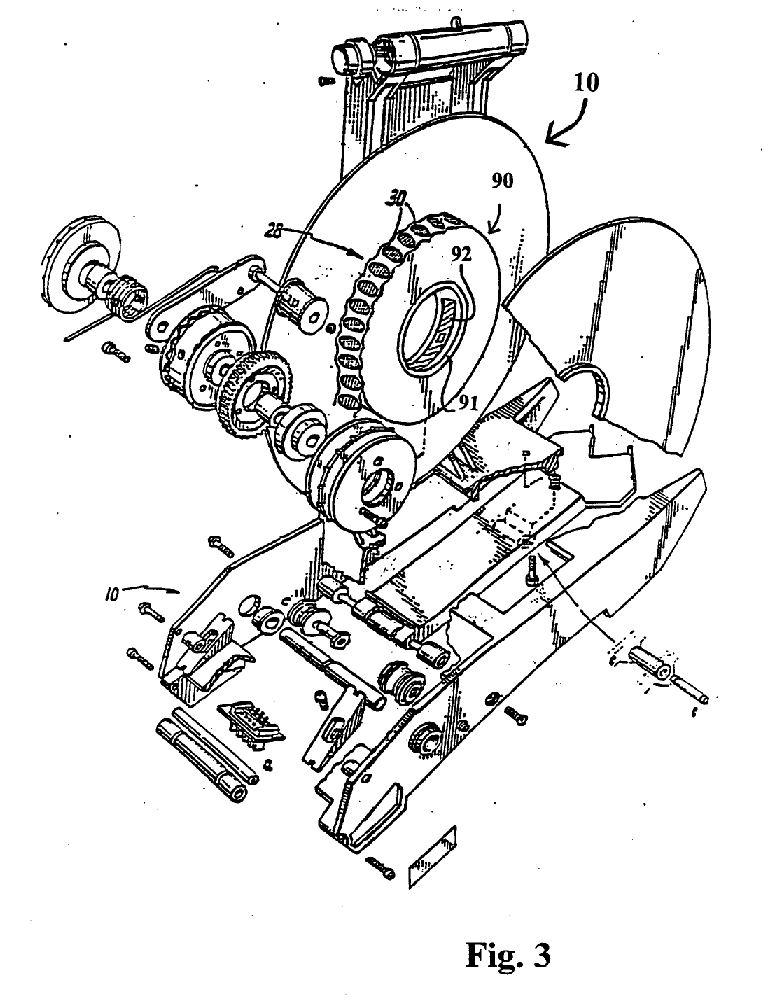

A label roll is illustrated in FIG. 2 and comprises a carrier strip 28 with labels 30 spaced therealong wound onto a core 91. As shown in FIG. 3, each label cassette 10 comprises a label roll that is laced onto said cassette and is adapted for removable attachment to a label apparatus for labelling. The label strips 28, labels 30 and cassettes 10 may be of the type shown and described in U. S. Pat. No. 4,896,793, incorporated herein by reference as if set forth in full. FIGS. 2 and 3 show the data tag 92 of the present invention as it is used in the cassette of U.S. Pat. No. 4,896,793. The data tag 92 may be a radio frequency (RF) or contact tag 92 placed inside the cylindrical core 91 which carries label strip 28. A detailed description of cassette 10 shown in FIG. 3 is contained in U.S. Pat. No. 4,896,793 and is not reproduced here in the interest of brevity.

The data tag 92 mounted on each label roll stores a unique identifier and/or specific label information. This information on the data tag includes, but is not limited to, the following:

Unique identifier,

PLU number,

Number of labels on the core,

Label reference number, and

Check sum value that is used to validate the tag data.

The unique identifier also acts as a link between the labels and the system database 120 maintained on a central data storage medium. The system database 120 will contain information concerning, for example, label roll identification, label size and type, customer identification, etc. The data tag 92 comprises either a radio frequency (RF) tag or a contact tag and is preferably formed integrally with the core 91. An acceptable RF tag is a Gemplus C240 readable by a Gemplus MEDIO S001, both available from Gemplus International SA, Aerogolf Center 1, Hohenfof 2633, Senningerberg, Luxembourg. The contact tag is preferably a Dallas 1-wire tag, available from Dallas Semiconductor Corp., 4401 S. Beltwood Parkway, Dallas, Tex. 75244.

The reader/controller 9 is responsible for the control of an individual label applicator. The reader/controller 9 is micro-controller based with digital input, digital output and serial communication capabilities. An acceptable micro-controller is a PIC16F877 by Microchip Technology Inc. 2355 West Chandler Blvd. Chandler, Ariz. 85224. The reader/controller 9 will also have the ability to read and/or communicate with either a RF tag or contact tag. The reader/controller 9 communicates with the RFID reader via RS232. To read the Dallas 1-wire tag, the reader/controller 9 could use a digital input line and reference line as described by Dallas Semiconductor Corp. This controller can be set-up to either apply labels on sight or apply based on information derived from the sizer. To apply labels on sight, an optical sensor detects the presence of a product, which signals the applicator to apply a label. In the other configuration, a signal is conveyed from the sizer via the machine controller 6 through the machine network 8. Labelling machines as well as sizers readily use these methods. The reader/controller 9 also includes a reader device, which is operable to read the unique identifier and label information for its respected label core. The reader/controller 9 is linked via a machine network 8 that transmits data read to the machine controller 6.

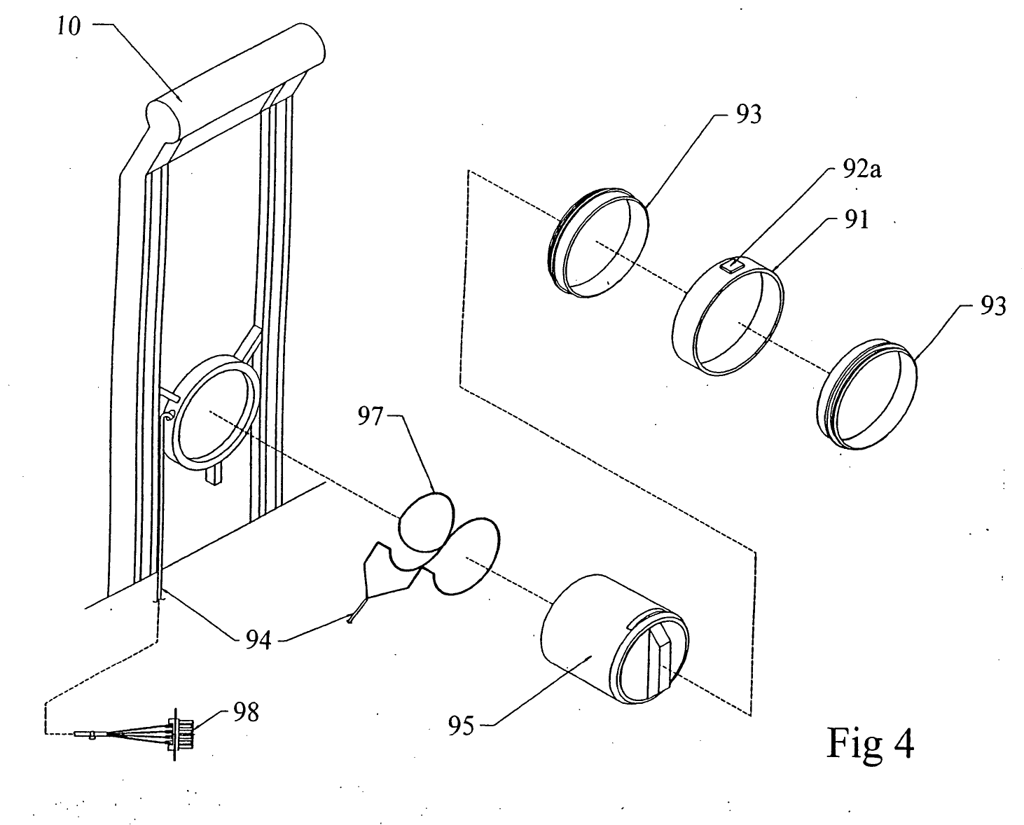

For the RF tag the reader device (such as the Gemplus MEDIO S001 reader) uses proven technology which can be readily purchased. These reader devices include an antenna and a serial communication port. The RF reader device is mounted in the label applicator and is connected to the reader/controller 9 through a RS232 serial port. FIG. 4 illustrates how the antenna 97 is mounted to the cassette 10 and connects to the Gemplus reader. The antenna 97 is mounted inside the cassette hub 95 and is coupled to the reader/controller 9 by way of a coaxial cable 94 that passes through a connector 98. The data tag 92a is fixed to a label core 91.

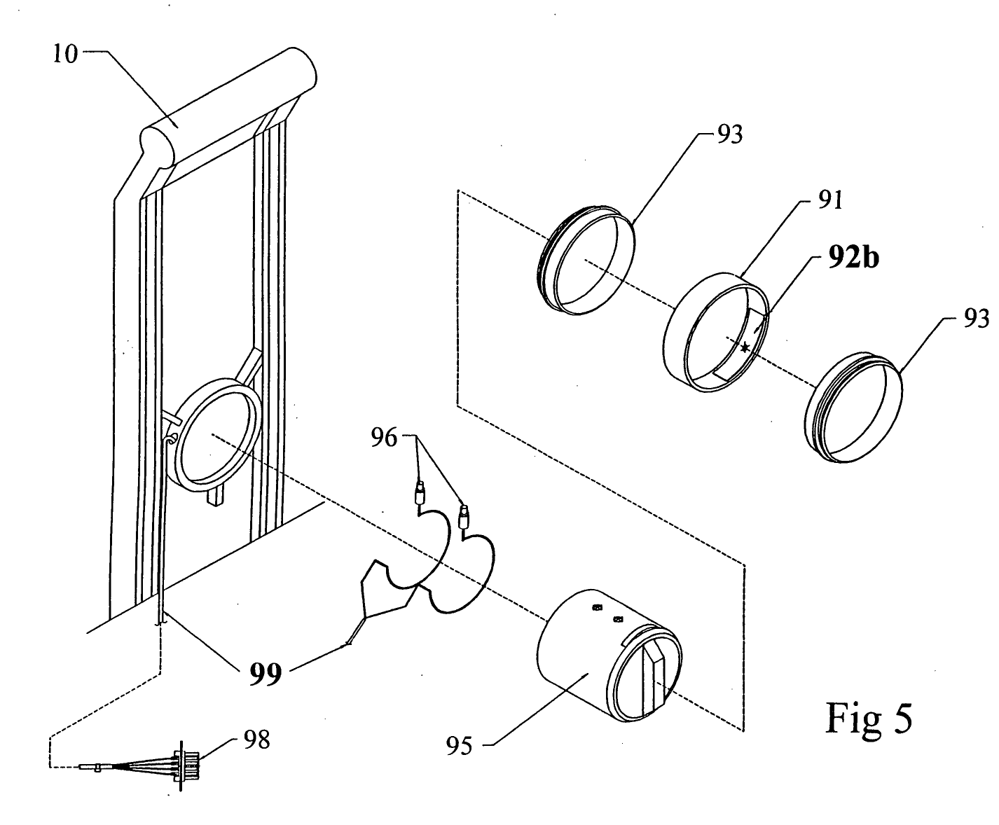

For the contact tag the reader/controller 9 receives tag information through a 1-wire cable. A detailed description of the communication protocol is described in the Dallas Semiconductor Corp. data sheet specification. FIG. 5 illustrates how connection is maintained between the data tag 92b and the reader/controller 9. Since the label core rotates as labels are dispensed, a slip ring 93 and brush 96 are configured to provide an electrical connection between the reader/controller 9 and the data tag 92b. The slip ring 93 is made of conducting material that make electrical contact to the data tag 92b when pressed into the label core 91 (upon which the labels are mounted, not shown.) As labels are dispensed the slip ring 93 slides over the cassette hub 95 which houses the brushes 96 making a continuous electrical connection. A twisted pair cable 99 connects the brushes 96 to the reader/controller 9 via a connector 98.

The machine controller 6 is a link between the reader/controller 9 and the site server 4. This controller also provides control to the label machine and is accessed with a user interface 7. The user interface 7 provides access to machine specific operations and machine set-up parameters.

The site server 4 receives data over a local network 5 from the machine controllers 6 that are associated with each set of respective label rolls and can store and process this data. For this purpose the site server 4 will preferably comprise a microprocessor or computer based system. The site server 4 can also have connected thereto peripheral devices (not shown) such as one or more display devices upon which data can be displayed and/or a printer in order that the data, whether raw or processed, can be viewed. The site server 4 will also connect to the system database 120 via the Internet 3.

User interface 7a may be provided to allow selected users access to some or all of the data contained within the site server 4 and/or system database 120. The user may access the site server 4 via the local network 5 or the Internet 3 as desired or as appropriate and, in either case, communication is arranged to be secure, possibly by use of encryption and/or password entry.

In use, the system is utilized in relation to multiple labelling machines, each of which applies labels to articles. Each of the labelling machines has a label cassette 10 of the type described above removably attached thereto. The label cassette 10 contains labels in roll form wound onto a core. Each label core 91 includes a data tag 92 upon which is stored unique identification information concerning the attached labels. When the label cassette 10 is attached to the machine, the reader/controller 9 reads the tag and transmits this via the machine network 8 to the machine controller 6. The machine controller 6 verifies that the data relating to the label is the “correct” label as defined by the label customer. The label customer will have entered information into the machine controller 6 as to what label should be applied. This will be done through the appropriate user interface 7. Once the machine controller 6 verifies that the labels are of the correct type for the application or machine then the labelling apparatus can operate. Once the labelling apparatus is operating and is applying labels to articles, the machine controller 6 counts the number of labels applied. This count is altered if a fault is discovered by the reader/controller 9. If the machine controller 6 does not verify the labels, the controller can disable the labelling machine to prevent erroneous labelling and/or operation of the machine being affected adversely.

It will be appreciated that by reading the number and type of labels applied, a further advantage is gained in that real-time analysis of label usage can be undertaken. This is particularly useful in the field of fruit labelling where it is usual for the labelling apparatus to be leased to the packhouse operator where fruit is labelled. Further, it is usual. for the lease fee to include at least an element that is dependent on machine usage and hence the number of labels used. Accordingly it is useful to correctly monitor usage of the labels supplied. The system of the present invention permits this to be done in a simple and convenient manner.

The machine controller 6 on each labelling machine is linked via a local network to the site server 4. The site server 4 then connects to the system database via the Internet 3. The site server 4 connects through the use of such technology as a modem. The label and/or machine supplier administers the system database 120. The system database 120 contains all data from every tag 92 that may include label type, label roll identification number, customer identification, etc. Such a system makes it possible for label usage to be monitored for each labelling apparatus and customer in order to calculate appropriate labelling charges. Furthermore, the system can be used by label and/or machine suppliers for stock control insofar as details of data from the data tags for all label rolls whether they be in stock or in use on labelling machines can be contained within the system database 120. The system database 120 can be queried by user interface 7a such that reports generated from the data and can be printed or presented in a usable media.

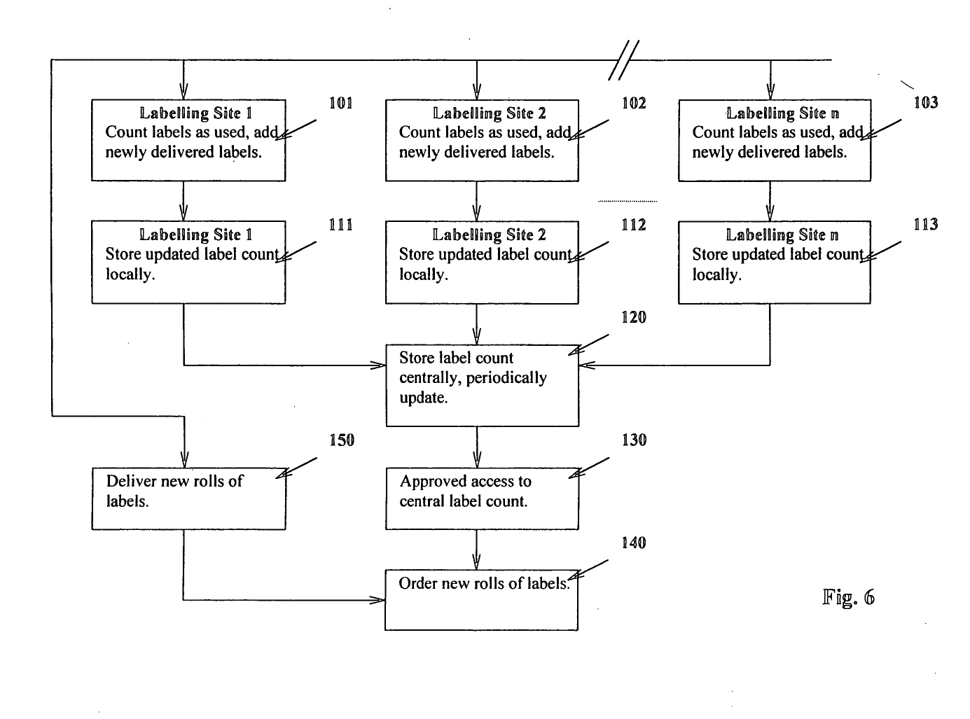

FIG. 6 is a flow chart illustrating the basic steps of the method incorporating the present invention. A plurality of n labelling sites is illustrated as sites 101, 102 and 103. As labelling runs are commenced and completed, the number and identity of labels is counted and recorded. Newly delivered rolls of labels to each site are added to inventory, and total label identity and counts are updated and stored locally at each site, shown as 111, 112 and 113. The stored, updated local label counts are automatically and periodically transferred from local sites 111, 112 and 113 to a central data storage facility or medium 120. Customers and representatives of the label supplier with appropriate credentials may obtain access to relevant portions of the central storage medium 120 from a monitor 130 convenient to the customer or representative. If new labels are needed, the customer or representative places an order for new labels as shown at 140. Most orders are placed with either the manufacturer of the labelling machines or approved alternate label suppliers; some orders may be filled by excess inventory of labels on hand at other labelling sites. In either event, the ordered rolls of labels are delivered by FedEx or UPS as shown at 150, or other delivery companies capable of making an automatic notification of completed delivery. The newly delivered rolls are added to the inventory of each labelling site 101, 102 and 103 and the cycle continues.

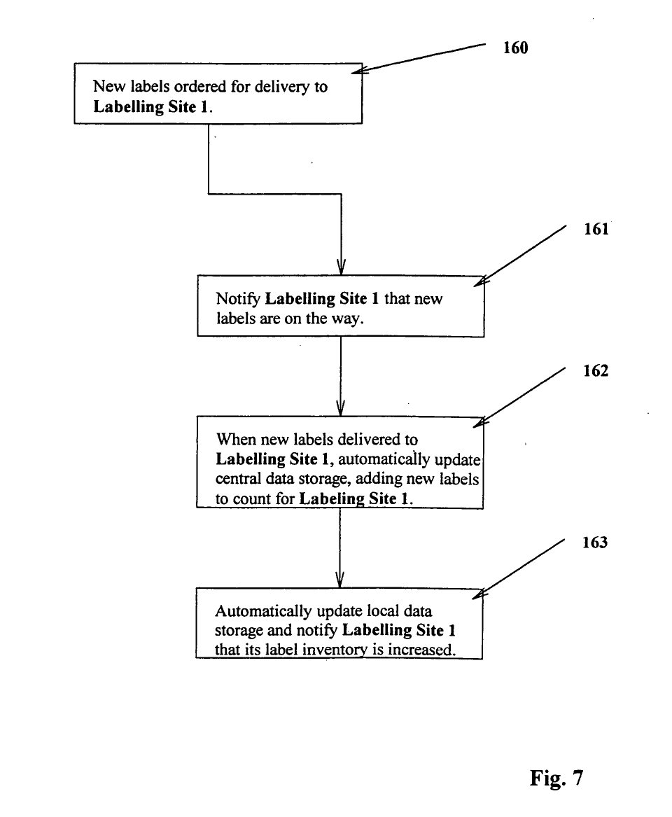

FIG. 7 illustrates the automatic augmentation of inventory when new label rolls are delivered. For example, a new order for labels delivered to site 1 is placed as shown at 160. When the new order is placed, a notice 161 is automatically sent to labelling site 1. When the newly ordered labels are delivered to site 1 as shown at 162, a delivery completion notice is automatically sent to the central data storage 120 by the carrier capable of sending such notice (such as FedEx or UPS). The central data storage 120 then updates its label count for site 1, and updates the local inventory data at site 1 as shown by 163, and notifies site 1 that its label inventory has been increased.

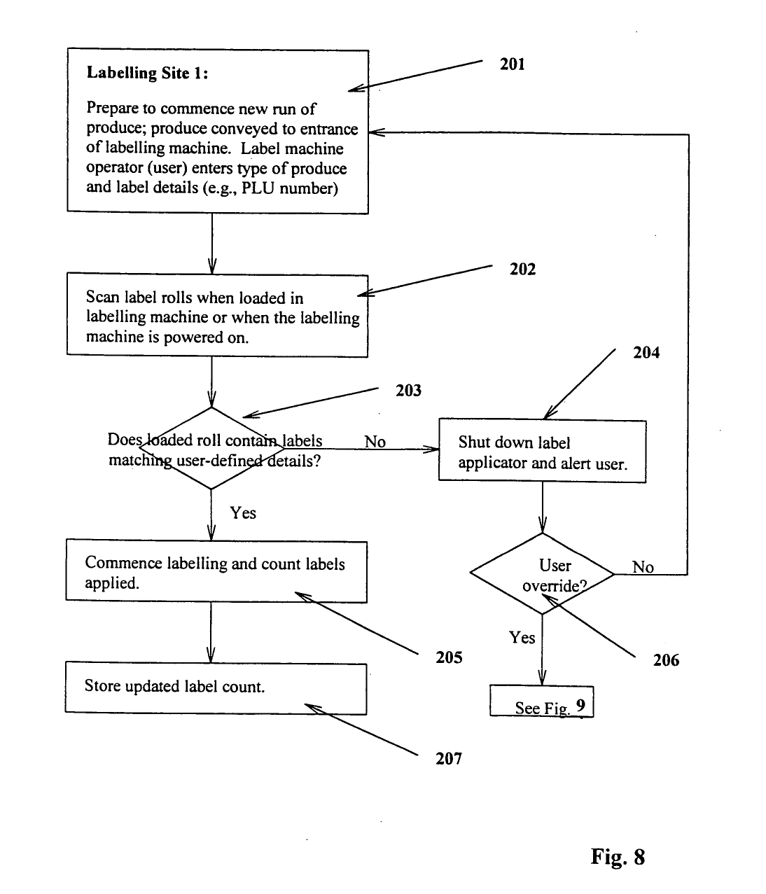

FIG. 8 is a flow chart illustrating the steps performed at each labelling site in counting labels used and in verifying use of approved and proper or correct labels. The first step 201 is to convey produce to the entrance of a labelling machine at site 1 and to have the label machine operator input into the labelling machine the coding for the specific produce about to be labelled, for example large Fuji apples PLU 4131. The second step 202 is to scan or read the data tag for each label roll as the cassette or cassettes are loaded. The third step 203 is to determine if each loaded label roll is approved (i.e. matches the label machine operator code and made by an approved label supplier). An automatic comparison by the labelling machine is made between the label roll(s) on the loaded label cassette(s) with the manually inputted code for the objects (e.g. Fuji apples) about to be labelled. If, for example, the loaded roll has Granny Smith apple labels, the codings do not match and the labelling machine is shut down automatically as shown at 204. Additionally, an audio and/or visual alarm may be generated. As discussed below, the label machine operator may be allowed to override the control system step 206, and the non-approved labels will be counted separately. Otherwise, the label machine operator must either load the cassette(s) with the appropriate label roll(s) or resubmit accurate coding for the produce to be labelled. As used herein and in the claims, an “unapproved label” refers to labels manufactured by a company other than the company that manufactured the labelling machines and have not been approved by the labelling machine manufacturer as compatible with the labelling machine. It is the policy of the assignee of this application, and affiliates of the assignee, as a manufacturer of labelling machines, to not unreasonably withhold its approval or consent for the use of labels supplied by others on labelling machines manufactured by the assignee (or affiliates of the assignee). If the label cassette is approved, the labelling run is commenced as shown at 205, and the labelling machine counts the labels used. At the end of the run, the label count is updated and stored locally at site 1 as indicated at 207.

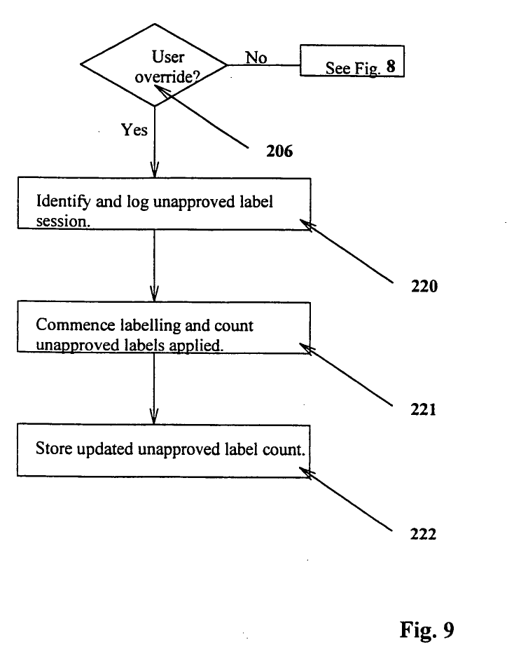

FIG. 9 illustrates the alternate steps if the customer is allowed to use non-approved labels. If, as shown in FIG. 7, the label machine operator elects to override the control system in step 206, the labelling machine identifies and logs a non-approved label session as shown at 220. When the run commences, the machine counts the unapproved labels used as shown at 221, and separately stores the number of unapproved labels used as shown at 222.

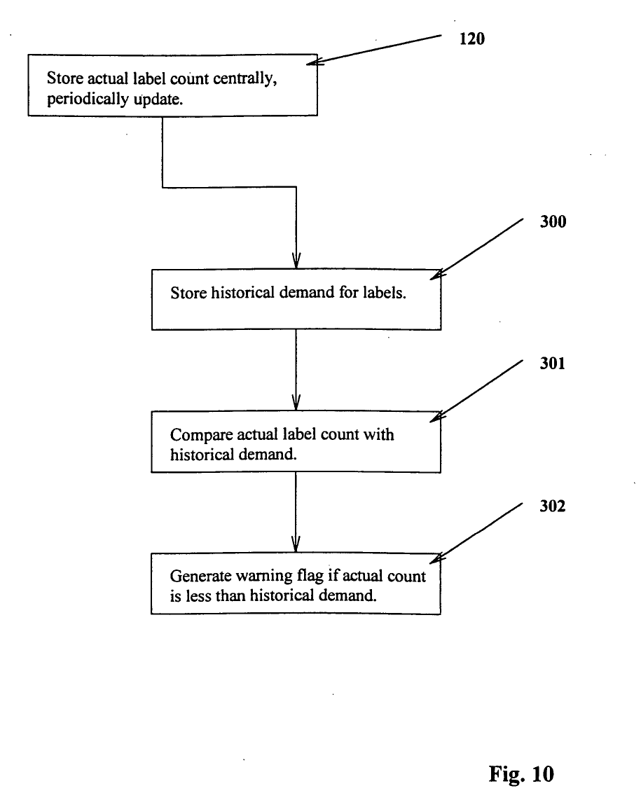

FIG. 10 illustrates the steps used to compare historical label demand with current label inventory to help determine if there is a shortage of labels on hand. As described above with respect to FIG. 6, the actual label count for sites 1 thru n is stored centrally as shown at 120 in FIGS. 1, 6 and 10. In FIG. 10, the historical demand for labels actually used in prior seasons at sites 1 thru n is also inputted at the central storage medium as shown at 300. The next step is 301, wherein the historical demand for labels is compared with actual labels on hand at each labelling site. For example, if labelling site 1 has averaged historical demand of 2 million Fuji apple labels used per season, but only 1 million Fuji apple labels are actually on hand at site 1, a warning is generated as shown at 302 that there is an apparent shortage of Fuji apple labels at site 1.

With respect to ordering labels, customers operating certain labelling sites will be able to place orders and check their account via the Internet any time of day any day of the week. This process will require the customer to log in using a user ID and password to access their account (may require more than one level of access, i.e. production ordering level of access and higher level to review customer account financial information-balance, payments). Once the customer has accessed their account, he can order labels, review past orders, review outstanding orders, inquire on shipment, query their outstanding balance/credit level, or review and/or download their label order history. Built into the order entry system for customers will be conveniences like a picture of their label along with the reference numbers, etc., along with facilities to post pending artwork for customer approval.

Depending on the label (generic or branded, stocked or not), the customer will be able to get a tentative cost, ship date and arrival date. The system will be able to compare the order requirements against inventory levels at various labelling sites to minimize fulfillment costs, and rough in the capacity for production and estimated completion date if needed. The customer will be able to select alternate shipment methods, which may trigger additional freight charges, as well as select expedited production, again triggering additional charges. With each label line item, the customer will be able to specify whether a partial order is acceptable, minimum quantity and date. The system will compute the order value and compare the customer's outstanding balance against the projected balance to alert the customer to credit issues. If the order meets all criteria and the labels are in stock, the order is accepted. Otherwise, the order would be accepted on a tentative basis and require review by the label supplier's customer service prior to release to the system.

Once the order is placed, the system will e-mail a tentative order confirmation to the customer and notice to the label supplier's customer service to prompt a review of the order. During the day, the orders could be processed during the course of business. At off-hours, the notices would queue and be handled in batch mode. The label supplier's customer service would review the order and, if any questions or issues arise, they would be sorted out with the customer. Once the order is officially cleared and released to the system, another e-mail will be sent notifying the customer of order acceptance with updated schedule information. At both stages, if the customer's account is past due or over balance, the system could automatically notify both the person ordering the labels and the customer's account payable contact that the account must be brought current before the order will release to ship.

Another source of orders would be agents of the company supplying the labels.

The system is capable of allowing placement of orders automatically. For example, the system may have automatic reorder points and reorder quantities for stocked labels based on consumption rates, projected lead times, and season timing. Again, these orders would require review by the label supplier's customer service prior to release to the system.

Another function for the system is automatic projecting and warning. The system would rapidly accumulate data to calculate maximum and average consumption rates of various labels. Consumption rates are governed by throughput of the fruit grading system on which labellers are often mounted-i.e. number of lanes and speed dictate the label consumption rate. Therefore for each customer, the system would calculate minimum days and average days inventory remaining on a per label basis. This type of tool would be highly valuable to a pack house manager and/or purchasing manager as well as the label supplier in planning label production and replenishment policies. On top of this, the system will perform calculations on a batch basis that calculate inventory levels and send e-mail warnings to customers and/or customer service for customers that are approaching re-order points.

Generic label consumption will be aggregated across all customers. For example, the system could aggregate each Washington Apple generic label applied across the state by all customers each day. With this information on label usage and inventory at each packer, the label supplier's customer service could project future inventory levels and optimize label production reorders.

Another functionality of the system is to enable label resale on behalf of customers. For example, if a customer has finished packing Fuji apples and still has 10 million labels remaining in their inventory, a flag field could be provided via the web for the customer to flag the inventory as “available” and desired date for replacement. With this flag, the label supplier could use the inventory to meet demand at other customer sites with near zero lead-time while removing the volume from production requirements. The benefit to the customer is reduced and perhaps zero inventory as well as guaranteed newly produced labels for the next season. Next season the benefit to the label supplier is fresh labels-and less chance of potential warranty claims, and increased size production runs. If the label supplier sold the labels, the system could place a replenishment order for the sold quantity for delivery at the desired date or beginning of the next season.

Another aspect of the system is the tracking of labels. The label identification system contains unique identifiers encoded into the cassette data tags so that the data tags can identify and distinguish themselves to the system. This information must be collected and properly mapped to the label order and label information at some point during the production process. Using the combination of generic information encoded into the label and unique label identifier information, the individual label rolls can be tracked through the system. This information is used to measure the number of labels applied from each roll. Information on the average number of labels applied per roll could be used to confirm production accuracy and to provide the basis for billing the customer on a “per-tap” basis.

As the label orders come through the system, the system will automatically capture information on each order and label roll.

By monitoring actual label demand rather than customer orders, the label supplier has the ability to react to and anticipate actual consumption, aggregate demand to increase order size, increase production efficiencies and reduce the overall label production cost. For example, using actual label demand, the label supplier is able to produce periodic generic label reorders for both generic and branded labels. Using the actual demand, the label supplier is able to predict when the customer should/must reorder based on historical consumption rates and current inventory. By adding one or more days warning of customer orders (demand), production has that much more time to produce the order and a much better chance of reacting and scheduling the order in an efficient manner. Rush orders, excess inventory and, more importantly, losses of fresh produce will decrease.

With visibility across all customers, the label supplier will have an array of tools at its disposal to react to the demand. For example, if the label is a generic label, the label supplier will be able to locate like labels across the system by running a query against reported customer inventories/label supplier inventories and redistribute adequate supply to meet the anticipated demand. Part of the query could be to find the same label in another customer's inventory where the two customers have the same ZIP code. This could either eliminate or reduce the demand to produce the labels and minimize the impact on scheduling and production. Either way, the benefit to production is fewer and larger aggregated orders with more control over the timing and delivery requirements.

In the case of a branded label, the system is able to either prompt the customer with sufficient notice to reorder or locate suitable generic labels to meet the demand—in either case, again, minimizing and/or managing the production demand.

With the above-described flexibility, the label supplier and customers can work together to minimize the number of label production runs and maximize the run size. The effect of increasing run size even marginally is significant; aggregating ten customer orders of one million labels in size into one each order of ten million would result in a production cost reduction on the order of 15%.

During the label production cycle, the data tags are encoded. Once the order is flagged as shipped, the system will automatically notify the customer representative via e-mail with the shipment contents, ship date, carrier, and providing tracking number as available. If the carrier is UPS or FedEx, the system will link into UPS and/or FedEx to receive automated notice that the order was signed for, what time, and by whom. Upon receipt of notification from UPS/FedEx, the system generates an e-mail to the customer that the order was received at their site, alerting them to the product on their own dock.

By building diagnostic capability into the on site hardware, service can track parts life as a function of usage. For example, if label applicators require overhaul after application of 5 million labels, the system can report and predict which applicators will require overhaul (and when) over the next few months. By changing from an overhaul regardless approach to overhauling as needed, unnecessary overhaul on machines used only on a limited basis would be eliminated. With better working applicators, reliability will increase.

Customer financing requirements can be facilitated by the recorded label usage provided by the system.

It is now well established practice for objects, such as fruit and vegetables, and particularly those intended for retail sale, to be labelled with information such as variety, origin, price-look-up (PLU) number, price, weight, quality, etc. This information can be directly readable; however, price information is generally in the form of a code so that price adjustments can be made without having to change the label. Generally, the coded information is machine readable such as a bar code, matrix or so-called snowflake code. The benefit of a label carrying coded information is that the label can be scanned at the point of sale to read the coded information and transfer it appropriately so that, for example, the price is transferred to a cash register and other data used for stock control.

One problem is wrong labels being applied to an object. If this happens, the retailer can overcharge for an item, which can result in substantial government fines. Mislabelled fruit can throw off the retailer's inventory tracking system; therefore, actual sales do not reflect recorded sales. Thus, large quantities of produce can be sold at lower than expected pricing, cutting profits significantly. A further problem of incorrect labelling can arise in connection with items of varying quality such as fruit or vegetables. It is quite common for fruit and vegetables to be graded prior to being labelled individually. The price of the products is fixed according to the type/variety/grade and the appropriate price information is provided on the label. Thus, when the fruit and vegetables are labelled, it is necessary that the label with the appropriate price information be applied to the correct product grade. Incorrect labelling in these circumstances does not result in the purchaser buying the wrong product, because he can see what he is buying, but in the wrong price being charged. If the price on the label is less than the correct price, i.e. the price on the shelf, the purchaser is unlikely to complain. Moreover if the price information is coded, the discrepancy between the price on the shelf and the price being charged is unlikely to be noticed at the point of sale. In a busy store selling large quantities of produce, very large sums of money can be lost as a result of incorrect labelling of this kind. Retailers frequently levy heavy financial penalties on suppliers that wrongly label fruit and, if this is picked up prior to the fruit being sold, the entire shipment can be rejected and returned.

The foregoing description of the invention has been presented for purposes of illustration and description and is not intended to be exhaustive or to limit the invention to the precise form disclosed. Many modifications and variations are possible in light of the above teaching. The embodiments were chosen and described to best explain the principles of the invention and its practical application to thereby enable others skilled in the art to best use the invention in various embodiments and with various modifications suited to the particular use contemplated. The scope of the invention is to be defined by the following claims.

what is claimed is:

1. An Internet based method for ordering and supplying selected coded labels to be applied to a variety of fruits and/or vegetables at a plurality of labelling sites, comprising the steps:
continuously and automatically inventorying the supply of different coded labels on hand for each said labelling site,
storing said label inventory data for each of said plurality of labelling sites,
allowing approved customers or representatives to initiate a computerized display of a portion of said stored label inventory data, and
providing means to allow said approved customer or representative to order additional selected labels for one or more of said labelling sites.

2. The method of claim 1 wherein each of said different coded labels is carried on a label roll mounted on a cassette and comprising the further steps:
providing in each of said label rolls an identifying code which uniquely describes the particular label identity and quantity of labels,
reading and inputting said identifying code when such label roll is activated and deactivated in a labelling machine, and
providing means for counting the number of labels utilized from each of said label rolls as said label roll is utilized in a labelling process.

3. The method of claim 2 wherein said identifying code is applied only to approved label rolls and wherein the use of non-approved label rolls is to be detected and measured, comprising the further steps:
providing means on each labelling machine to detect the activation of a non-approved label roll,
providing means to count and record the number of non-approved labels utilized by said labelling machine, and
automatically recording and storing the number of non-approved labels utilized by said labelling machine.

4. The method of claim 2 wherein said identifying code is applied only to approved label rolls and wherein the use of non-approved label rolls is to be detected and prevented, comprising the further steps:
providing means on each labelling machine to detect the loading of a non-approved label roll, and
providing means on each of said labelling machines for shutting down said labelling machine when a non-approved label roll is loaded thereon.

5. The method of claim 2 comprising the further step:
inputting into each labelling machine the coding for the particular fruit or vegetable prior to beginning a labelling run,
comparing said inputted coding to said label roll identifying code, and
beginning the labelling run only if the inputted code matches said label roll identifying code.

6. The method of claim 2 comprising the further step:
inputting into each labelling machine the coding for the particular fruit or vegetable prior to beginning a labelling run,
comparing said inputted coding to said label roll identifying code, and
shutting down said labelling machine if the inputted code does not match said label roll identifying code.

7. The method of claim 2 comprising the further steps:
providing means in each of said labelling machines to count the number of labels applied by that machine in a given period of time,
storing the number of labels applied by each of said labelling machines in a given period of time.

8. The method of claim 7 comprising the further steps:
automatically displaying predetermined recommended service required by each of said labelling machines as a function of the total number of labels applied by each labelling machine in a given time frame.

9. The method of claim 7 comprising the further step:
using the stored number of labels applied by each labelling machine in a given time frame to automatically generate financial billing statements for use of said labelling machine based upon the number of labels applied in a given time frame.

10. The method of claim 2 wherein it is desired to automatically enter into the inventory data additional label inventory corresponding to a label order being delivered to a specific labelling site, comprising the further steps:
notifying a labelling site when an order for coded labels is being shipped to said labelling site,
shipping said order to said labelling site by a shipping method wherein an automated notice is generated and transmitted to a data storage medium when said order is delivered to said labelling site,
inputting said delivered order to said data storage medium to increase the recorded inventory stored on said storage medium by an amount corresponding to said delivered order, and
automatically notifying said labelling site that said delivered label order is being added to its inventory.

11. The method of claim 1 comprising the further steps:
storing at a data storage medium expected label demand for each of said labelling sites,
periodically comparing the recorded label inventory recorded on said data storage medium for each labelling site with said expected label demand, and
generating warning flags whenever said comparison indicates a predetermined low label inventory for any of said labelling sites.

12. The method of claim 2 comprising the further steps:
historically tracking demand for a given particular coded label at a given number of said labelling sites over a given period of time, and
utilizing said historic label demand to schedule and to initiate production runs of said particular coded labels.

13. The method of claim 12 comprising the further step:
scheduling and initiating said production runs in a manner to minimize the number of production runs for a given coded label within a given time frame.

14. An apparatus for use in a labelling machine, said apparatus being capable of carrying a predetermined quantity of selected coded labels used to label fruits and/or vegetables, said coded labels identifying a specific type of fruit or vegetable, the apparatus comprising:
a core,
a label strip wound onto said core, said label strip carrying a known quantity of labels each carrying data relating to a specific, branded or generic, fruit or vegetable,
a cassette carrying said core and label strip,
a data tag means carried by said core, said data tag means carrying data sufficient to uniquely identify the labels on said label strip including the specific label identity and quantity, and
means allowing said data tag means to be read automatically when said cassette is loaded into said labelling machine.

15. The apparatus of claim 14 wherein said data tag means is a radio frequency (RF) tag.

16. The apparatus of claim 14 wherein said data tag means is a contact tag.

17. The apparatus of claim 14 wherein said data tag means is a Dallas 1 wire tag.
